(19) United States
(12) Patent Application Publication
(10) Pub. No.: US 2018/0240657 A1
(43) Pub. Date: Aug. 23, 2018

(54) COLLISION CELL HAVING AN AXIAL FIELD

(71) Applicant: Thermo Fisher Scientific (Bremen) GmbH, Bremen (DE)

(72) Inventor: Johannes SCHWIETERS, Ganderkesee (DE)

(21) Appl. No.: 15/752,835

(22) PCT Filed: Aug. 11, 2016
(86) PCT No.: PCT/EP2016/069181

§ 371 Date: Feb. 14, 2018

(30) Foreign Application Priority Data
Aug. 14, 2015 (GB) 1514480.1

(51) Int. Cl. H01J 49/00; H01J 49/04; H01J 49/06; H01J 49/30

(52) U.S. Cl. CPC H01J 49/004; H01J 49/30; H01J 49/063; H01J 49/0481

(57) ABSTRACT

The invention provides a mass spectrometer that comprises a collision cell having an axial electric field that enhances transmission of light ions, especially elemental ions, through the collision cell, relative to heavier ions. The invention also provides methods of mass spectrometry that employ an axial electric field that is provided in a collision cell.

### STATEMENT RELATING TO FUNDING

The work leading to this invention has received funding from the European Research Council under the European Union's Seventh Framework Programme (FP7/2007-2013)/ERC grant agreement n° FP7-GA-2013-321209.

### FIELD

The invention relates to a mass spectrometer, in particular a mass spectrometer having a collision cell with a drag field. The invention furthermore relates to methods of mass spectrometry using collision cells having a drag field.

### INTRODUCTION

Mass spectrometry is an analytical method for qualitative and quantitative determination of molecular species present in samples, based on the mass to charge ratio and abundance of gaseous ions.

In inductively coupled plasma mass spectrometry (ICP-MS), atomic species can be detected with high sensitivity and precision, at concentrations as low as 1 in 10¹⁵ with respect to a non-interfering background. In ICP-MS, the sample to be analyzed is ionized with an inductively coupled plasma and subsequently separated and quantified in a mass analyzer.

Precise and accurate isotope ratio measurements very often provide the only way to gain deeper insight into scientific questions which cannot be answered by any other analytical technique. Multicollector ICP-MS is an established method for high precision and accurate isotope ratio analysis. Applications of ICP-MS are in the field of geochronology, geochemistry, cosmochemistry, biogeochemistry, environmental sciences as well as in life sciences. However, elemental and molecular interferences in the mass spectrometer can limit the attainable precision and accuracy of the analysis.

These interferences can be present in the sample material itself or are generated by sample preparation from a contamination source, such as chemicals used, sample containers, or by fractionation during sample purification). Contaminating species can also be generated in the ion source or in the mass spectrometer.

In order to achieve high precision and accurate isotope ratio measurements, extended physical and chemical sample preparation is applied to get clean samples free from possible interferences and contamination that can interfere in the mass spectrum. Typical concentrations of analyte in sample material used in isotope ratio ICP-MS are in the range of parts per billion. The analyte of interest may also be concentrated in small inclusions or crystals within a heterogeneous sample material, for example in rock samples.

Extended quality control steps are integrated into the sample preparation to ensure that the sample preparation itself does not lead to changes in the isotope ratio of the sample material. Every sample preparation step comes along with the possibility of adding contamination to the samples and/or causing isotopic fractionation of the analyte to be extracted from the original sample material, which could be for instance a rock, a crystal, soil, a dust particle, a liquid and/or organic matter. Even if all these steps are taken with great care there still is the chance of contamination and incomplete separation and interferences in the mass spectrum.

Ideally one would like to completely avoid the chemical sample preparation step. Moreover a chemical sample preparation is impossible if a laser is used to directly ablate the sample and flush the ablated material into the ICP source. In such cases, there is no chemical separation of the desired analyte from the sample matrix and all the specificity has to come from the mass analyzer and the sample introduction system in the mass analyzer. Specificity describes the ability of an analyzer to unambiguously determine and identify a certain species in a sample. One way to achieve specificity in a mass spectrometer is to ensure that the mass resolving power M/(AM) of the mass analyzer is large enough to clearly separate one species from another species where AM is meant to be the mass difference of both species and M is the mass of the species of interest. This requires very high mass resolution in case of isobaric interferences of species with the same nominal mass. For sector field mass spectrometers high mass resolution comes along with using very narrow entrance slits to the mass analyzer and the small entrance slits significantly reduces the transmission and thus the sensitivity of the mass analyzer and becomes an unpractical approach where very high mass resolving power is required. This is a special challenge for mass spectrometry instrumentation where current technical solutions are limited.

The Inductively Coupled Plasma (ICP) ion source is a very efficient ion source for elemental and isotopic analysis using mass spectrometry. This is an analytical method that is capable of detecting elements at very low concentration, as low as one part in 10¹⁵ (part per quadrillion, ppq) on non-interfered low-background isotopes. The method involves ionizing the sample to be analysed with an inductively coupled plasma and then using a mass spectrometer to separate and quantify the thus generated ions.

Ionizing a gas, usually argon, in an electromagnetic coil, to generate a highly energized mixture of argon atoms, free electrons and argon ions, generates the plasma, in which the temperature is high enough to cause atomization and ionisation of the sample. The ions produced are introduced, via one or more stages of pressure reduction, into a mass analyser which is most commonly a quadrupole analyser, a magnetic sector analyser or a time-of-flight analyser.

A description of ICP mass spectrometers can be found in the articles A Beginner's Guide to ICP-MS by Robert Thomas (SPECTROSCOPY 16(4)-18(2), April 2001-February 2003), the disclosure of which is hereby incorporated by reference in its entirety (however, where anything in the incorporated reference contradicts anything stated in the present application, the present application prevails).

A known design of multi-collector (MC) ICPMS instrument is the NEPTUNE™ or NEPTUNE Plus™, as described in brochures and operating manuals from Thermo Scientific, the disclosures of which are hereby incorporated by reference in their entirety (however, where anything in the incorporated reference contradicts anything stated in the present application, the present application prevails).

High precision mass analysers allow for high mass resolution to separate elemental ions from molecular species which to some extent are inevitably formed inside the ICP source (e.g. OH+, NO+, CO+, CO₂+, ArO+, ArN+, ArAr+, etc.) and interfere with elemental ions. Thus, certain elements are known to have relatively poor detection limits by ICP-MS. These are predominantly those that suffer from artefacts or spectral interferences generated by ions that are derived from the plasma gas, matrix components or the solvent used to solubilize samples. Examples include ⁴⁰Ar¹⁶O for determination of ⁵⁶Fe, ³⁸ArH for determination of ³⁹K, ⁴⁰Ar for determination of ⁴⁰Ca, ⁴⁰Ar⁴⁰Ar for determination of ⁸⁰Se, ⁴⁰Ar³⁵Cl for determination of ⁷⁵As, ⁴⁰Ar¹²C for determination of ⁵²Cr and ³⁵Cl¹⁶O for determination of ⁵¹V.

With a high mass resolution magnetic sector multicollector mass spectrometer the molecular species can be separated along the focal plane of the mass spectrometer so that just the elemental ions can be detected while the molecular interferences are discriminated at the detector slit (see Weyer & Schwieters, International Journal of Mass Spectrometry, Vol. 226, Number 3, May 2003, herein incorporated by reference). This procedure works well for interferences where the relative mass deviation between the analyte and the interference is in the range of (M/ΔM)<2,000-10,000 (M: mass of the analyte, AM: mass difference between analyte and interference).

With a sector mass spectrometer high mass resolution usually comes along with reduced ion optical transmission into to the mass analyser because high mass resolution requires narrower entrance slits and smaller apertures to minimize second or third order angular aberrations further down the ion beam path from the entrance slit to the detector. In the particular case where the amount of sample is limited or the analyte concentration in a sample is low the reduced sensitivity in high mass resolution mode is a significant problem. It directly results in reduced analytical precision because of poorer counting statistics at effectively reduced transmission through the sector field analyser. Therefore high mass resolution is not generally a practical solution to eliminate interferences and to gain specificity even in cases where the mass resolving power of the mass spectrometer would be sufficient to discriminate the interferences.

There are other applications where isobaric interferences of elemental ions cannot be avoided by sample preparation and where mass resolving power >>10,000 would be required to separate the interfering species. One example is the analysis of ⁴⁰Ca with argon based plasma. There is a strong interference of elemental ⁴⁰Ar+ on ⁴⁰Ca+. The required mass resolution to separate both species would be >193,000 which is much greater than that which can be achieved by a magnetic sector field analyser.

One solution to this problem is provided by collision cell technology (ICP-CCT) that includes a collision/reaction cell that is positioned before the analyser. This collision cell adds another possibility to achieve specificity for the analysis. Instead of mass resolving power it uses chemical reactions to distinguish between interfering species. Into this cell, which typically comprises a multipole operating in a radiofrequency mode to focus the ions, a collision gas such as helium or hydrogen is introduced. The collision gas collides and reacts with the ions in the cell, to convert interfering ions to harmless non-interfering species.

A collision cell may be used to remove unwanted artefact ions from an elemental mass spectrum. The use of a collision cell is described, e.g., in EP 0 813 228 A1, WO 97/25737 or U.S. Pat. No. 5,049,739 B, all herein incorporated by reference. A collision cell is a substantially gas-tight enclosure through which ions are transmitted. It is positioned between the ion source and the main mass analyser. A target gas (molecular and/or atomic) is admitted into the collision cell, with the objective of promoting collisions between ions and the neutral gas molecules or atoms. The collision cell may be a passive cell, as disclosed in U.S. Pat. No. 5,049,739 B, or the ions may be confined in the cell by means of ion optics, for example a multipole which is driven with alternating voltages or a combination of alternating and direct voltages, as in EP 0 813 228. By this means the collision cell can be configured so as to transmit ions with minimal losses, even when the cell is operated at a pressure that is high enough to guarantee many collisions between the ions and the gas molecules.

For example, the use of a collision cell where about 2% H₂ is added to He gas inside the cell selectively neutralizes ⁴⁰Ar+ ion by low energy collisions of the ⁴⁰Ar+ with the H₂ gas and a resonant charge transfer of an electron from the H₂ gas to neutralize the ⁴⁰Ar+ ions (see Tanner, Baranov & Bandura, 2002, Spectrochimica Acta Part B: Atomic Spectroscopy, 57:1361-1452, herein incorporated by reference). This charge transfer mechanism is very selective and efficiently neutralizes argon ions and thus discriminates Argon ions from ⁴⁰Ca+. These types of effects are sometimes called chemical resolution (Tanner & Holland, 2001, in: Plasma Source Mass Spectrometry: The New Millennium, Publisher: Royal Soc of Chem) in comparison to mass resolution in the case of mass spectrometer.

In addition to the charge transfer reaction other mechanisms inside the collision cell using other collision gases or mixtures of collision gases may be applied to reduce interferences. These mechanisms include: kinetic energy discrimination due to collisions inside the collision cell (e.g., Hattendorf & Guenther, 2004, J. Anal Atom Spectroscopy 19:600), herein incorporated by reference), fragmentation of molecular species inside the collision cell (see Koppenaal, D., W., Eiden, G., C. and Barinaga, C., J., (2004), Collision and reaction cells in atomic mass spectrometry: development, status, and applications, Journal of Analytical Atomic Spectroscopy, Volume 19, p.: 561-570, herein incorporated by reference), and/or mass shift reactions inside the collision cell. This toolbox of ICP-CCT can come closer to the goal of detection specificity using direct sample analysis with significantly reduced sample preparation but there are still analytical problems and interferences which cannot be resolved by interfacing a collision cell to a mass spectrometer.

By careful control of the conditions in the collision cell, it is possible to transmit the desired ions efficiently. This is possible because in general the desired ions, those that form part of the mass spectrum to be analysed, are monatomic and carry a single positive charge, i.e. they have lost an electron. If such an ion collides with a neutral gas atom or molecule, the ion will retain its positive charge unless the first ionisation potential of the gas is low enough for an electron to transfer to the ion and neutralise it. Consequently, gases with high ionisation potentials are ideal target gases. Conversely, it is possible to remove artefact ions whilst continuing to transmit the desired ions efficiently. For example the artefact ions may be molecular ions such as ArO+ or Ar₂+ which are much less stable than the atomic ions. In a collision with a neutral gas atom or molecule, a molecular ion may dissociate, forming a new ion of lower mass and one or more neutral fragments. In addition, the collision cross section for collisions involving a molecular ion tends to be greater than for an atomic ion. This was demonstrated by Douglas (Canadian Journal Spectroscopy, 1989 vol 34(2) pp 36-49), incorporated herein by reference. Another possibility is to utilise reactive collisions. Eiden et al. (Journal of Analytical Atomic Spectrometry vol 11 pp 317-322 (1996)) used hydrogen to eliminate many molecular ions and also Ark, whilst monatomic analyte ions remain largely unaffected.

For analysis of samples with unknown elemental composition, and in particular for samples with unknown and/or exotic isotope composition, it can be useful to first obtain a full mass spectrum of the sample, to assess its elemental composition and thereby obtain information about possible interferences, and subsequently make isotope ratio determinations for selected masses. For example, samples with extreme or unusual isotopic ratio can typically be found in extra-terrestrial samples like meteorites or in nuclear samples that have been artificially enriched. Methods known in the art for doing so require the use of two mass analysers, one that determines the full spectrum and another that determines isotope ratios in a predetermined range.

In general, ICP-MS is a method for determining a range of elements across a large mass range. Current mass spectrometers typically use collision cells to remove or attenuate interferences, by kinetic energy discrimination, fragmentation and/or resonant charge transfer. In the process known as collisional focusing, collisions between the gas and the ions cause a reduction in the velocity of the ions. This in turn leads to the ions becoming focused near the axis. It would be ideal to be able to use a single instrument configuration to analyse all known elements.

One problem that frequently arises in current elemental analyses is that for lighter elements, such as Li and B, only a few collisions within the collision cell can result in complete energy loss, which leads to the ions becoming trapped within the collision cell. As a result, sensitivity for lighter elements is severely hampered by collision cells when they are filled with collision gas. Presently, the only way to circumvent this problem is to evacuate the collision cell when analysing light elements, which is time consuming and reduces sample throughput.

It would be desirable to maintain high transmission even for light elements when the ions of interest have similar mass to the collision gas (e.g. for the case of Li, which has a similar mass to He commonly used as a collision gas). The problem, however, becomes even more pronounced in cases of heavier collision gases, such as O₂ or NH₃, or even larger molecules. The fact that the transmission of ions with similar mass as the collision gas or below suffer from transmission losses is a severe hindrance for multi-element analysis using collision cells. Currently, it is only possible to perform full elemental analysis with compromises in sensitivity for the lighter elements, or else in sequential mode, i.e. the collision gas needs to be pumped away before the lighter elements are measured. This slows down throughput and makes the analytical workflow more complex.

### SUMMARY

The present invention addresses ways to facilitate the detection and analysis of ion abundance, in particular for analysis of elemental ions, and in particular embodiments for isotope ratio analysis, by use of collision cells that employ an axial drag field, i.e. an axial electric field that exerts a drag force on ions within the cell.

By means of the invention, the drag field allows an increase in the transmission in the case of Li from a few % up to almost 100%. The drag field is generated by electric fields and can be switched on and off within microsecond (μs) timescales and thus improves the sensitivity for the lighter elements dramatically. The invention allows use of collision cells for analysis of elemental ions in a simple and fast workflow with high throughput and without compromising transmission.

The present invention provides in one aspect a mass spectrometer for mass analysis of elements in a sample, comprising
a. at least one ion source, for generating an ion beam from a sample, the ion beam comprising elemental ions and optionally molecular ions that interfere with elemental ions in a mass spectrum;
b. at least one collision cell arranged downstream of the ion source, the collision cell having an internal volume through which ions travelling in an axial direction from the ion source are transmitted;
c. at least one mass analyzer, arranged downstream from the collision cell,
d. at least one detector, for detecting ions that are analyzed in the mass analyser, wherein the collision cell is configured to provide an axial electric field in the volume.

Also provided is a method of mass spectrometry, the method comprising steps of:
i. transmitting elemental ions from an ion source into a collision cell that comprises at least one ion guide, wherein the collision cell contains at least one reaction or collision gas;
ii. applying an axial electric field gradient in the collision cell for improving transmission of ions through the collision cell; and
iii. transmitting ions from the collision cell into a mass analyzer for mass analysis.

The invention also extends to a method of transmitting elemental ions through a collision cell in a mass spectrometer, the method comprising:
i. providing at least one multipole ion guide within the collision cell;
ii. applying an axial electric field gradient in the collision cell multipole for improving transmission of ions through the collision cell, and
iii. transmitting ions in an axial direction through the multipole ion guide wherein the axial electric field exerts a force upon the ions in the direction of transmission.

Also provided is a method of increasing sensitivity of an elemental mass analysis, the method comprising:
i. providing an ion beam comprising at least one elemental ion into a multipole collision cell;
ii. applying an axial electric field gradient in the collision cell ; and analyzing an ion abundance or isotope ratio of the at least one elemental ion transmitted through the multipole collision cell.

The mass analyser can be a double-focusing sector field mass analyser. The mass analyser can also be a single sector field mass analyser. The double focusing sector field mass analyser can comprise at least one magnetic field sector and at least one electric field sector. The single-focusing sector field mass analyser can be a magnetic sector field mass analyser. The mass analyser can also be a quadrupole mass analyser, or it can be a time of flight (TOF) mass analyser, an ion cyclotron (ICR) mass analyser or an electrostatic trap mass analyser.

The detector can be selected from detectors that are known in the art. In some embodiments, such as those having a sector field analyzer, the detector is, or comprises, a multicollector array. A combination of Faraday cups and ion counters can be installed in the detector. For example, 9 Faraday cups in addition to up to 8 ion counters can be installed. The axial channel can be equipped with a switchable collector channel behind the detector slit, where the ion beam can be switched between a Faraday cup and an ion counting detector. On each side of this fixed axial channel, there can be four moveable detector platforms, each of which can carry one Faraday cup and attached to it one or more miniaturized ion counting channels. Every second platform can be motorized and adjusted using a computer operated controller. The detector platforms between two motorized platforms can be pushed into position by the two adjacent platforms, allowing for full position control on all moveable platforms. In other embodiments, such as those with quadrupole analyzers, the detector may comprise a secondary electron multiplier (e.g. discrete dynode or continuous dynode type).

The collision cell can comprise at least one multipole ion guide, which can be selected from a quadrupole, a hexapole or an octupole. Preferably, the multipole is a quadrupole. The quadrupole can be a three-dimensional quadrupole or it can be a two-dimensional, i.e., linear, quadrupole. The rods of the multipole can be round rods, or they can be hyperbolic rods. In some embodiments, the multipole is a flatapole, in which the rods are flat, i.e. the rods have a flat surface.

In a typical collision cell, there can be arranged at least one multipole, most commonly a quadrupole. The multipole comprises a plurality (usually four, six or eight) rods that are arranged in a parallel fashion along a central axis, and are spaced slightly apart so that the rod assembly defines an internal volume. The resulting multipole is usually enclosed in a chamber, to maintain adequate gas pressure (e.g., about 10⁻³ mbar). During use, only RF voltages are applied to the rod set, so that there is no mass discrimination by the rods, and thereby act as an ion guide. A rod offset voltage can also be applied, which is uniform along the rods, and which is used to control collision energy in the cell.

In conventional setup of ICP-MS, the collision cell has a uniform field in the axial direction of the cell. There is only a small field gradient at the exit of the collision cell, which is determined by the potential applied to the extraction aperture.

It is however possible to have an axial drag field has an electric potential gradient along the axis of the cell. Quadrupoles having axial fields are known in the art and are disclosed in e.g. U.S. Pat. No. 5,847,386 and U.S. Pat. No. 7,675,031, the entire contents of which are hereby incorporated by reference.

A variety of drag cells are thus known and can be used in the context of the present invention. These include, but are not limited to, (1) quadrupole rod sets having rods that are tapered along their axial direction, such that the wide ends of the rods are at the entrance to the collision cell and the narrow ends are at the exit from the collision cell; (2) quadrupoles having rods that are slanted but of uniform diameter, i.e. the ends of one pair of rods are located closer to the central axis at one end of the cell, and the ends of the other pair of rods are located closer to the central axis at the other end of the cell. A DC potential applied to the rod configuration in (1) and (2) will in both cases result in an axial potential along the central axis; (3) quadrupoles having rods that are surrounded by a cylindrical shell that is divided into segments that are separated by insulating rings, and wherein an axial field is generated by applying different voltages to the different segments; (4) quadrupole assemblies having four auxiliary rods arranged between the quadrupole rods, and wherein an axial field is generated by applying a voltage gradient across the length of the auxiliary electrodes in a parallel fashion; (5) applying a non-uniform resistive coating to the rods in the quadrupole, so that an axial field is generated along the rods when a DC voltage is applied; (6) having rods that are made from a resistive material in a non-symmetrical fashion along their lengths, so as to generate a field when a voltage is applied to the rods; (7) dividing the rods into segments with insulating rings, and applying different voltages to the segments; (8) having rods from insulating material having conductive metal bands at their ends, connected by resistive material; (9) coating the rods with a low-resistivity material, and applying different voltages to the two ends of the rods.

Exemplary auxiliary electrodes include those disclosed in U.S. Pat. No. 7,675,031, wherein electrodes are disclosed that are provided as finger electrodes that are arranged on thin substrates and disposed between the quadrupole rods. By applying a progressive range of voltages along the length of the auxiliary electrode assembly, an axial field is generated along the rod assembly.

The axial field is arranged to exert a force on the ions in their direction of motion as they enter the cell (the forward direction). In this way, ions entering the cell in the forward direction are accelerated along the collision cell in the same, forward direction. The ions are typically positively charged ions. The axial field can be applied along the entire rod set. Alternatively, the axial field is applied to a portion of the rod set along its axial direction, for example by placing auxiliary electrodes along a portion of the rods. Preferably however, the axial field stretches across the entire quadrupole rod set.

In some preferred embodiments, there is a potential gradient across the quadrupole rods, or a portion of the quadrupole rods, of about 0.02 V/cm to about 4 V/cm, such as about 0.1 V/cm to about 1 V/cm, or about 0.2 V/cm to about 0.5 V/cm. This is preferably the value on the central axis of the collision cell or quadrupole rod set. The potential that is applied to the collision cell or quadrupole, e.g. to axial field rods thereof, to achieve this gradient will vary depending on the geometry of the collision cell. In some embodiments, the applied potential is in the range of about 50 V to about 120 V.

The axial field can furthermore change uniformly and in a progressive manner, i.e. the electrical field changes monotonically along the length of the quadrupole. The axial field can also be stepwise and progressive, i.e. the field changes unidirectionally but in discrete steps. Preferably, however, the axial field has a monotonically progressive field gradient.

The collision cell can be linear, and the axis of the ion beam through the cell also linear. However, the collision cell can also be non-linear, for example when provided as a curved multipole assembly. Accordingly, the axis of the collision cell can be linear or it can be curved or non-linear. The axis can also be partially linear and partially non-linear.

These and other means for generating drag fields in multipoles are known to the skilled person, and are contemplated for use with the present invention.

In some embodiments, the multipole comprises a plurality of rod electrodes configured to be supplied with RF voltage, wherein the rods are arranged according to at least one of the following arrangements to provide an axial electric field gradient: (i) at least some (preferably all) of the rods are slanted along the axial direction, (ii) the rods are each provided as a plurality of segments spaced along the axial direction wherein stepped voltages, preferably via a resistive divider, are applied to the segments, (iii) the rods have a resistive coating or comprises a resistive material, (iv) at least one, and preferably all, of the rods are tapered along the axial direction, and (v) at least one, and preferably all, of the rods have a coating comprising a low resistance material.

The rods can be provided as a plurality of segments along the axial direction, wherein the same RF potential is applied to the different segments, but different DC potential, so as to generate an axial electric field gradient.

The collision cell can comprise at least one auxiliary electrode disposed to create an axial field within the volume of the collision cell. The collision cell can preferably be configured to provide an axial field along all of, or a portion of, the internal volume. Preferably, the collision cell is configured to provide an axial field along all of the internal volume.

The ion source that provides the elemental ions can be an inductively coupled plasma (ICP) ion source, secondary ion mass spectrometry (SIMS) ion source. Preferably, the ion source is an ICP source. Typically, the nature of the ion source and the sample is such that the source does not only produce elemental ions, but it also produces molecular ions. Therefore, it is highly desirable to eliminate or reduce molecular ions where they interfere with elemental ion of interest and this to some extent is carried out in the collision cell. High mass resolution can also be used to determine between elemental ions of interest and molecular ion interferences, however high mass resolution usually comes at the cost of transmission and this is why it is often preferred to use a collision cell to fragment molecular interferences and/or to generate mass shifts with the cell.

By applying a drag field in the collision cell the opportunity is provided to maintain a high transmission rate of even light ions that otherwise would lose their kinetic energy and even become trapped in the collision cell due to collisional energy loss. The drag field enhances the transmission of the lighter ions, compared with having no drag field, because it accelerates the ions in the collision cell that otherwise would have lost their momentum due to collisions with gas in the collision cell. This problem is particularly acute when analysing ions that have a mass that is comparable to that of the collision gas. Thus, while the problem is most severe for the lightest ions, such as Li+ and B+, when using a light gas such as He in the collision cell, the problem becomes more severe when using heavier collision gases such as O₂ or NH₃.

Thus, although the use of kinetic energy discrimination in a collision cell is a routine method in ICP-MS to remove or attenuate interferences, the introduction of collision gas creates analytical problems, in particular for light masses. In practical applications, the loss of transmission for light elements during elemental analysis, for example by ICP-MS, is a problem that severely hampers the analysis of such species. Present instruments only allow a full elemental analysis that either compromises sensitivity for the lighter elements, or requires a time-consuming serial mode of operation, during which the collision gas is pumped away from the collision cell before the lighter elements are measured. This reduces sample throughput and makes the analytical workflow more complex. Furthermore, it may not be possible to pump away the collision gas due to the sample signal only being transient, for example when using laser ablation or for fast GC and LC coupling setup.

Through the application of a drag field in the collision cell as described herein, transmission can be dramatically increased in the cell. For example, in the case of Li+ when He is used as collision gas, transmission can be increased from being only a few % with no drag to almost 100% when a drag field is applied. Furthermore, the drag field can be rapidly switched on and off, or within a timescale of only a few microseconds. The drag field can furthermore be adjusted during a scan, so that each element can be measured with an optimized drag field that maximizes its residence time within the collision cell. Thus, a first elemental ion species can be measured with the drag field in the collision cell having a first setting, i.e. a different voltage gradient along the axial volume in the cell. Following measurement of the first elemental ion, a second elemental ion can be measured at a second setting of the drag field that can be different from the first setting.

The mass spectrometer can comprise one, or a plurality of, ion guides, that receive an ion beam and provide an electrical field that guides the beam along a path. The at least one ion guide can receive the ion beam from the ion source and direct it towards downstream segments of the instruments. Multiple ion guides can be provided in the instrument, as is known in the art. The ion guide can be a multipole, such as quadrupole, a hexapole or an octupole.

The mass spectrometer can also comprise at least one mass filter that is arranged upstream from the collision cell. The mass filter can be a mass filter that comprises electrodes that are provided with a combination of RF and DC voltages in a mass-to-charge (m/z) filtering mode, and are provided with substantially only RF voltage in a non-filtering mode. In other words, the non-filtering mode is preferably an RF-only mode. In this mode, the ions of all mass to charge ratios are stable within the mass filter and as a consequence will be transmitted through it. It is possible that a small DC voltage be applied to the electrodes, in addition to the RF voltage, during the transmission mode. Preferably, the DC/RF voltage ratio in the non-filtering mode is 0.0 (i.e., RF only, no DC voltage), or no more than 0.001, or no more than 0.01, or no more than 0.05, or no more than 0.1. Preferably, the DC/RF ratio is 0.0.

Preferably, the mass filter is a multipole filter. The electrodes of the mass filter are therefore preferably the rods of a multipole mass filter. The multipole can be a quadrupole, a hexapole, or an octupole. Preferably, the multipole is a quadrupole. The quadrupole can be a three-dimensional quadrupole or it can be a two-dimensional, i.e., linear, quadrupole. The rods of the multipole can be round rods, or they can be hyperbolic rods.

There can also be at least one electrostatic lens arranged in the mass spectrometer. The lens is preferably a dual-mode electrostatic lens, for selectively and alternately transmitting or reflecting an ion beam. The electrostatic lens can be configured so that the lens has two modes of function, wherein during a first mode, the lens transmits an ion beam than enters the lens along a first axis through the lens. When arranged upstream from the collision cell, the lens will in this mode transmit an ion beam that enters the cell into the collision cell. In a second mode, the lens can reflect an incoming ion beam backwards and towards the side, with respect to the direction and motion of the incoming beam, and into an off-axis detector. When the upstream mass filter is operated in a mass-filtering mode, for example in a mass-filtering mode where the mass filter scans mass windows of less than 1 amu for obtaining a mass spectrum, ions that are transmitted by the mass filter will be reflected in the electrostatic lens and into the off-axis detector. In this way a full mass spectrum can be obtained.

In addition to being either transmitted or reflected in the electrostatic lens, the ion beam is also focused when transmitted and/or directed backwards towards the side of the assembly, into the collision cell or into the detector.

The off-axis detector can be any type of detector that is typically used in mass spectrometry, such as an electron multiplier (continuous or discreet), also called SEM (Secondary Electron Multiplier) detector, an array detector, a Faraday cup, a photon counter, a scintillation detector, or any other detector that is useful for detecting ions, in particular in the context of a mass spectrometer. Preferably, the detector is capable of fast time response. The detector can therefore preferably be an electron multiplier, such as a continuous dynode multiplier or a discreet dynode multiplier.

Switching time between a normal (transmission) mode and a reflection mode of the electrostatic lens is preferably short. The switching time can be less than 5 ms, less than 4 ms, less than 3 ms, less than 2 ms, less than 1 ms, less than 0.5 ms, less than 0.2 ms or less than 0.1 ms. Preferably, the switching time is less than 1 ms.

The detector can be placed upstream from the lens assembly, adjacent to the upstream mass filter, i.e. closer to the mass filter than to the collision cell. Such an arrangement benefits from the superior vacuum in the vicinity of the mass filter, compared with a downstream arrangement, for example near the collision cell, where vacuum conditions are relatively poor. As a consequence, superior detection conditions will be provided, irrespective of whether a downstream collision cell is being pressurised with collision gas or not.

The setup has a further advantage that a mass spectrum of an incoming ion beam can be rapidly determined, using the first mass filter (e.g., a quadrupole operated in a scanning mode), wherein during the reflection mode, the electrostatic lens is set to reflect the incoming ion beam backwards into the detector. During this time, a full mass spectrum, or a mass spectrum within a predetermined mass region, of an incoming beam can be determined. Such a scan can provide important information about the composition of the sample being analysed, which can for example be a sample of unknown composition (e.g. a meteorite sample) or a sample with unknown isotope composition. Following the mass scan, which is very fast when the first mass filter is a multipole, a switch to a second mode of a downstream mass filter can be performed, for example for determining isotope ratio of specific elements or molecular species in the sample. This setup has distinct advantages over present solutions, in which a sample has to be split, e.g. into two separate instruments, for different type of mass analysis in the two instruments.

The mass spectrometer preferably comprises at least one power supply and at least one electronic controller, for regulating the electric potential applied to various components of the instruments, including ion source, ion guides, including the collision cell, mass filters, mass analyser and detectors, the elongated rods of the collision cell multipole and/or the at least one auxiliary electrode so as to generate the axial electric field gradient in the reaction chamber.

The collision cell further can comprise at least one gas inlet for admitting at least one gas into the collision cell. The gas can be a reaction and/or a collision gas. For example, the gas can be selected from He, H₂, O₂, NH₃, and SO₂ or mixtures of any two or more thereof.

In the methods according to the invention, elemental ions that are generated in the ion source are transmitted into the collision cell. An axial electrical field gradient is applied to the cell, so as to prevent a complete loss of kinetic energy of the ions due to collisions within the cell and thereby improve their transmission. The axial field allows to increase the transmission for the lighter elements dramatically. For example, the transmission of Li increases from a few % up to almost 100%. The drag field is generated by electric fields and can be switched on and off within μs timescales and thus improves the sensitivity. The axial field can be generated by at least one of at least one of: (i) applying a range of stepwise voltages in the axial direction to at least one electrode of the collision cell that is elongated in the axial direction, (ii) providing a resistive coating to at least one electrode of the collision cell that is elongated in the axial direction and connecting a DC voltage supply to an end of the at least one electrode, (iii) providing at least one electrode elongated in the axial direction that is slanted along the axial direction; wherein the at least one electrode is at least one elongated rod of the multipole and/or is at least one auxiliary electrode. Other methods of generating an axial field in a multipole collision cell that are known in the art are also possible, for example as disclosed in U.S. Pat. No. 5,847,386 and U.S. Pat. No. 7,675,031. Preferably, the range of stepwise voltages changes monotonically and results in a progressive axial electric field gradient in the collision cell that accelerates ions through the multipole in the axial direction. Ions that are transmitted from the collision cell can be transmitted into a downstream mass analyser, where the ions are analysed and detected.

In certain embodiments, the methods are adapted for elemental ions that have a relatively low mass (especially those similar in mass to, or of lower mass than, the collision gas) and are as a consequence more susceptible to energy loss caused by collisions with gas in the cell (e.g., He, H₂, O₂, NH₃, and/or SO₂) that can lead to the ions becoming trapped and/or poorly or slowly transmitted through the collision cell leading to loss of detection sensitivity for such ions. The relatively low mass elemental ions therefore preferably comprise elemental ions that have an atomic mass similar to, or the same as, or less than the atomic or molecular mass of a reaction or collision gas in the collision cell. The gas can be introduced into the cell at a flowrate of 0.5 to 10 mL/min, preferably 1 to 8 mLₙ/min, more preferably 2 to 6 mLₙ/min. In this context, mLₙ/min refers to a flow rate in mL/min at normal pressure of 1 atmosphere. In certain embodiments, the elemental ions have an atomic mass of less than 50 amu, of less than 40 amu, of less than 30 amu, of less than 25 amu, of less than 20 amu, or of less than 15 amu. In some preferred embodiments, the elemental ions have an atomic mass of less than 30 amu, of less than 20 amu or of less than 15 amu, or of less than 10 amu. The elemental ions may include at least one of lithium, beryllium and boron ions.

The axial electric field gradient of the invention substantially improves the transmission of the light elemental ions through the collision cell relative to heavier elemental ions that have an atomic mass greater than the light elemental ions

The collision cell can be filled with at least one reaction or collision gas prior to the transmission of ions through the collision cell. The cell thus contains the gas during transmission of the ions through the cell. The collision gas can preferably be selected from He, H₂, O₂, NH₃, and SO₂, and the collision cell can be filled with the gas at a flow rate of 0.5 to 10 mLₙ/min, preferably 1 to 8 mLₙ/min, more preferably 2 to 6 mLₙ/min.

The collision cell can enable one or more of fragmentation, charge transfer reactions and kinetic energy discrimination, in order to attenuate interferences.

Another aspect of the invention is directed to matrix effects, which can make quantitative analysis complicated and inaccurate. In ICP-MS without a mass filter upstream of the collision cell, all ions of a sample enter the collision cell. The collisions slow down the ion beam and result in extended residence time of ions inside the collision cell. Thus, the interaction time of the major matrix ion beam with the trace concentrations of some elements can influence the transmission through the cell and cause a matrix effect. The axial electric field applied in the collision cell in accordance with the invention can reduce the residence time inside the collision cell and as such reduce the matrix effect, while still allowing fragmentation and charge transfer reactions and kinetic energy discrimination to occur. As such, the axial drag field can be selected to reduce the residence time in the collision cell for reducing matrix effects. The drag field can even be adjusted during one scan so that each element is measured with an optimized drag field and optimized residence time within the collision cell.

As a consequence of collisions within the collision cell, the energy spread of ions within the cell is reduced. In the absence of a drag field, large transmission loss is typically observed, especially for light elements. Furthermore, transmission loss will typically be greater at higher gas pressure within the collision cell. By applying a drag field within the cell, an increased gas pressure can be applied than otherwise would be possible, since the drag field enhances transmission through the cell. In general however, there will be an increased resolution in the mass analysis of transmitted ions from the collision cell. The energy spread of the elemental ions after transmission through the collision cell can be less than 5 eV, less than 3 eV, less than 2 eV or less than 1 eV. In some cases, ions entering the collision cell have an energy spread of about 3 eV, but when exiting the cell the energy spread is less than 1 eV. As a consequence, the energy spread of the elemental ions after transmission through the collision cell can be reduced by at least about 50%, at least about 60%, at least about 70% and preferably by at least about 80%, compared to the energy spread of the ion generated by an ion source.

The axial electric field can be adjusted during a mass analysis so that each element is measured with an optimized axial electric field and thereby optimized residence time within the collision cell. For example, ions could be transmitted in a scanning mode into the collision cell, and the axial field in the cell adjusted to optimize the residence time and transmission through the collision cell.

The ions can be subsequently transferred to a mass analyser that is arranged downstream of the collision cell, and can be any one of a double focusing multicollector mass analyzer, a single-focusing sector field mass analyzer, in particular a magnetic sector field mass analyzer, a quadrupole mass analyzer, a time of flight (TOF) mass analyzer, an ion cyclotron resonance (ICR) mass analyzer, an RF ion trap mass analyzer, or an electrostatic trap mass analyser. There can also be a combination of mass analyzers in a serial arrangement downstream from the collision cell.

In some embodiments, an ion abundance or isotope ratio of at least one elemental ion that is transmitted through the multipole collision cell is determined in the mass analyser. The mass analyser can in such embodiments preferably be a multicollector sector mass analyser, such as a double focusing multicollector mass analyzer or a single-focusing sector field mass analyzer, in particular a magnetic sector field mass analyser.

The above features along with additional details of the invention are described further in the examples below, which are intended to further illustrate the invention but are not intended to limit its scope in any way.

### BRIEF DESCRIPTION OF THE DRAWINGS

The skilled person will understand that the drawings, described below, are for illustration purposes only. The drawings are not intended to limit the scope of the present teachings in any way.

FIG. 1 shows a schematic overview of a mass spectrometer employing a collision cell configured to generate a drag field, in accordance with the invention.

FIG. 2 shows an example of increased sensitivity of Li detection, by employing a drag cell during elemental analysis of Li.

### DESCRIPTION OF VARIOUS EMBODIMENTS

In the following, exemplary embodiments of the invention will be described, referring to the figures. These examples are provided to provide further understanding of the invention, without limiting its scope.

In the following description, a series of steps are described. The skilled person will appreciate that unless required by the context, the order of steps is not critical for the resulting configuration and its effect. Further, it will be apparent to the skilled person that irrespective of the order of steps, the presence or absence of time delay between steps, can be present between some or all of the described steps.

It should be appreciated that the invention is applicable for elemental and isotope analysis of solid liquid or gaseous samples in general by mass spectrometry techniques. In general, therefore, the sample that is being analyzed in the system will be variable. Further, the system and method according to the invention is illustrated in the embodiments that follow with a preferred embodiment of a mass spectrometer for determining isotope ratio.

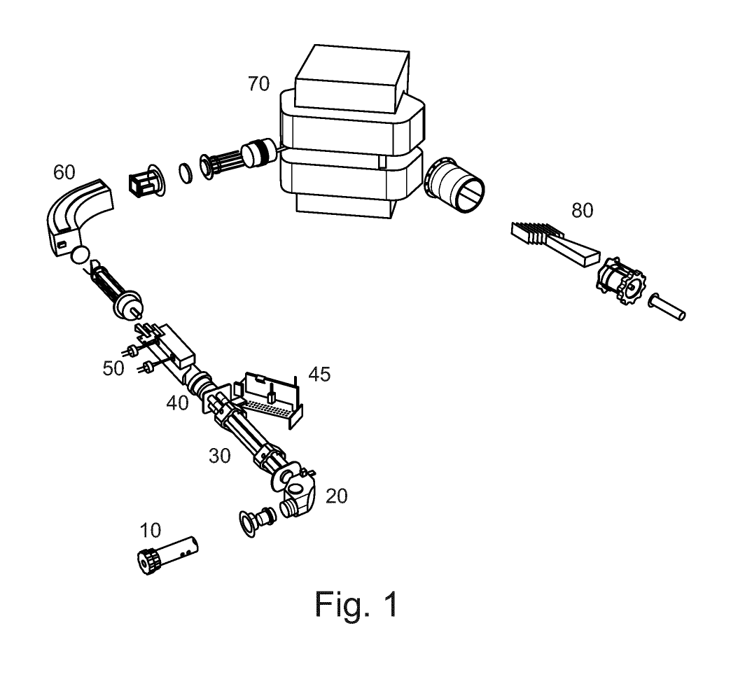

Referring to FIG. 1, there is schematically shown an example of a mass spectrometer that includes a collision cell according to the invention. Here, a double focussing multicollector inductively coupled plasma mass spectrometer (ICP-MS) is shown. The instrument has an ICP source 10 and a deflection lens 20 arranged upstream from a quadrupole mass filter 30 and a dual-mode reflection lens 40 that is optional, but when present is preferably arranged between the mass filter and the collision cell 50. The optional reflection lens can be used for transiently diverting the incoming ion beam to a supplementary analysis section of the instrument, which can for example be an electron multiplier detector. By inclusion of the lens and such a detector, the first mass filter can be used to obtain a full mass spectrum of the ion beam, and during such analysis the lens is set to reflect the ion beam that is transmitted by the mass filter into the detector.

An advantage of the reflection lens is the placement of the detector 45 for detecting ions that are reflected in the lens 40, adjacent to the quadrupole. The pressure in this region of the instrument is significantly lower (i.e., higher vacuum) than within the chamber surrounding the downstream collision cell, or near the upstream ICP source. As a consequence, noise at the off-axis detector 45 can be kept to a minimum, leading to improved signal-to-noise when the mass filter is set to obtain a full mass spectrum, and the reflection lens configured to reflect transmitted ions into the detector.

The collision cell 50 comprises a quadrupole assembly that is configured to generate a drag field. For example, the collision cell can include auxiliary electrodes that generate an axial field in the cell. The quadrupole collision cell can also include modified rods for generating axial fields, as described herein.

Elemental ions are generated in the ICP source from a sample, including for example low mass ions such as Li+ ions. The ions are transmitted through the mass filter, which is set to transmit ions in a selected mass range that includes the elements that are being analysed. The mass filter can preferably be set to transmit ions in a mass range that does not include the mass of plasma Ar+ isotopes, where argon is used to generate the plasma. This is expected to lead to reduced interference in the collision cell and hence improved sensitivity. The ions are transmitted through the electrostatic lens 40, when present, and into the collision cell 50, which is flooded with a collision gas such as He. The axial field in the collision cell increases the speed of transmissions of the incoming ions, in particular such that lighter elemental ions such as Li+ that would otherwise significantly lose momentum in the cell are able to travel through the collision cell with reduced energy loss. From the collision cell, the ions are transmitted into the downstream dual sector multicollector instrument, where their isotope composition is determined, such as ⁶Li+ and ⁷Li+ in the case of lithium, and ¹⁰B+ and ¹¹B+ in the case of boron.

Downstream from the collision cell is a mass analyser that comprises an electric sector 60 and a magnetic sector 70, followed by a multicollector detector assembly 80.

Collision cells in current mass spectrometers are used to remove or attenuate interferences by kinetic energy discrimination, fragmentation, resonant charge transfer or mass shifting by ion-molecule reactions. Ideally one would like to work with one instrumental configuration for all elements of the periodic table. One problem that arises when analysing lighter elements like Li and B is that just a few collisions with the collision gas, which in most cases is He, can result in a complete energy loss of the elemental ions. As a result, these lighter ions essentially come to rest, and are trapped inside the collision cell and therefore not detected. This is why the sensitivity for light element detection is severely hampered by collision cells when they are filled with gas.

In current instruments, this can only be circumvented when the gas in the collision cell is pumped away, for light element analysis. However, this is time consuming and reduces throughput of the instrument. The present invention provides a solution to this problem, since the loss of sensitivity for lighter elements can be significantly reduced by the use of a collision cell with an axial drag field.

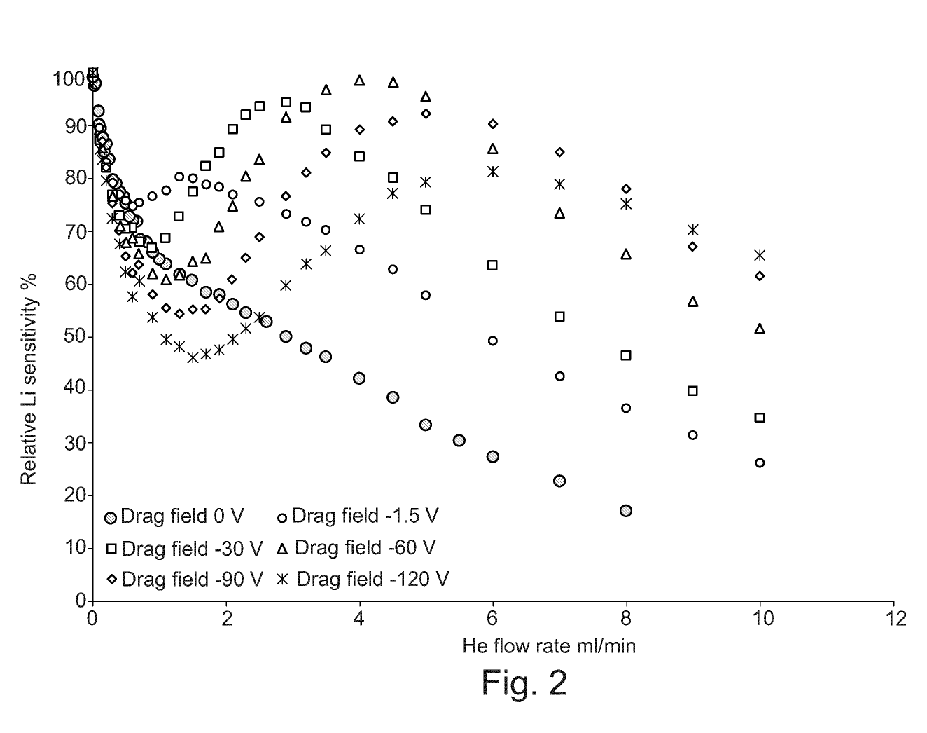

Exemplary data that illustrate the advantage of using a collision cell with a drag field in the analysis of Li is shown in FIG. 2. For this analysis, a drag field high energy collision dissociation (HCD) cell, as used on the Q Exactive mass spectrometer (Thermo Scientific), was installed in an instrument configured as shown in FIG. 1. He is used as the collision gas.

The light dots (bottom curve) show the decrease in Li ion transmission through the collision cell without any axial drag field as a function of He flow rate. With increasing He flow rate the transmission drops significantly, and is as low as 10% at 9 ml/min He flow. This flow rate is about an average He flow rate that is needed to achieve collisional focusing for mid mass and high mass elements. Applying a drag field in the cell significantly improved Li sensitivity, and the increase in sensitivity is proportional to the applied field. Thus, as an increased field is applied, there is a peak in the transmission curve that is obtained with increased He flow rate, and the curve peak shifts to the right, towards a higher He flow rate, as the drag field is increased. One can thus see that when applying drag voltages in the range of 100 Vat 9 ml/min He flow the transmission of Li is greater than 60%. This means that the sensitivity of Li detection, compared with no drag field, is improved by more than a factor of 6. Comparable improvement in detection can be obtained for other lighter elements, such as boron.

Although the improved transmission and detection for elemental analysis has been illustrated by the particular instrument configuration and for Li analysis as shown by the data in FIG. 2, it should be appreciated that the advantage of using a drag collision cell for elemental analysis can be realized in a variety of instrument setups. Thus, the concept of using an accelerating drag field within the collision cell for improving transmission and detection of elemental ions, in particular light element ions, can be implemented in mass spectrometers that are suitable for such analysis.

Another advantage of using the drag cell is that due to multiple collisions in the cell the energy spread of the ions is reduced much more effectively than without the axial drag field. The smaller energy spread because of more collisions is expected to result in improved abundance sensitivity in the mass spectrum, in particular in the mass range of the actinides. In nuclear applications for instance the accurate detection of the ²³⁶U peak is critical as it serves as an indicator of whether the nuclear material has been processed in a reactor or not. However, during conventional isotope analysis, the peak tail of the major ²³⁸U isotope interferes to some extent on the ²³⁶U peak. The long peak tail of the ²³⁸U peak is caused by the scattering of the ²³⁸U ion beam with apertures or residual gas particles in the sector analyzer that results in a small energy loss and change in direction. To detect minor traces of ²³⁶U the ion beam is therefore usually passed through an RPQ energy filter lens in order to discriminate against scattered ²³⁸U ions. The RPQ energy filter lens sits behind the axial detector slit of the multicollector detector and rejects all ions below a certain energy level and therefore acts a high pass filter to discriminate against scattered ²³⁸U ions which have suffered some energy loss. Applying an axial drag field in the collision cell is expected to eliminate the need for such analysis, resulting in simplified instrument configuration and increased sensitivity during isotope analysis.

Without cooling, the energy distribution of the ions generated in the ICP source using a balanced coil or a shielded torch is in the range of a few eV. With collisional cooling and in particular with using the drag cell which allows for even more collisions, the energy distribution of the ions can be significantly reduced and thus the energy distribution of the ions becomes much sharper and the filter action of the energy filter can be much more specific. For thermal ionization ion sources the energy spread of the generated ions is less than 1 eV and the abundance sensitivity achieved with the energy filter lens is about 10 times better compared to ICP instruments. With improved collisional cooling using a drag cell, the abundance sensitivity can be improved for an ICP source as well.

The drag cell allows for more collisions inside the collision cell. More collisions means also more interactions with the gas inside the reaction cell. Therefore the drag cell allows the collision cell to be operated with significantly larger gas pressures as can be appreciated from the data shown in FIG. 2. For reactions that have a rather low reaction rate, overall reaction yield can be significantly increased by using a drag cell because of larger gas pressure and as a consequence more interactions between incoming ions and reaction gas. In general, if the gas pressure is increased, a concomitant increase in the reaction yield is expected. As a consequence, the drag cell can also be used for chemistry within the collision cell, for example for mass shift reactions within the cell, with improved reaction yields.

In summary, the present invention provides numerous advantages, including:
a. improved sensitivity for lighter elements in collision mode;
b. universal operation mode for all elements without compromises in sensitivity reduction for the lighter elements; this is important for quadrupole mass analyzer instruments;
c. reduced energy spread of ions and thus improved abundance sensitivity for large dynamic range isotope ratio analysis;
d. improved energy spread to enhance higher mass resolution;
e. operation at higher gas pressures to allow for higher yield on gas phase reactions inside the collision cell.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. A method of isotope ratio mass spectrometry, the method comprising steps of:
i. transmitting elemental ions from an ion source into a reaction cell that comprises at least one ion guide, wherein the reaction cell contains at least one reaction;
ii. applying an axial electric field gradient in the reaction cell for improving transmission of ions through the reaction cell, wherein the axial electric field gradient can be adjusted so that during a mass analysis, a first element is analysed with a first setting of the axial electric field gradient in the reaction cell and a second element is analysed using a second setting of the axial electric field gradient in the reaction cell;
iii. transmitting ions from the reaction cell into a sector field mass analyzer for mass analysis followed by detecting ions using a multicollector, and
analyzing an isotope ratio of detected ions.

2. The method of claim 1, wherein the elemental ions comprise elemental ions that have an atomic mass similar to, or the same as, or less than the atomic or molecular mass of a reaction or reaction gas in the reaction cell.

3. The method of claim 1, wherein the elemental ions comprise light elemental ions that have an atomic mass of less than 40 amu.

4. The method of claim 1, wherein the axial electric field gradient improves the transmission of the light elemental ions through the reaction cell relative to heavier elemental ions that have an atomic mass greater than the light elemental ions.

5. (canceled)

6. The method of claim 1, wherein the reaction cell comprises at least one multipole ion guide.

7. (canceled)

8. (canceled)

9. The method of claim 1, wherein prior to being transmitted through the reaction cell, the ions are transmitted through at least one mass filter.

10. The method of claim 1, wherein the mass analyzer is one of: a double focusing multicollector mass analyzer, a single-focusing sector field mass analyzer, a quadrupole mass analyzer, a time of flight (TOF) mass analyzer, an ion cyclotron resonance (ICR) mass analyzer, an RF ion trap mass analyze, or an electrostatic trap mass analyzer.

11. The method of claim 1, further comprising transmitting the ion beam through at least one electrostatic lens that is arranged upstream from the reaction cell, wherein the electrostatic lens is operable in a first mode, in which the ion beam is transmitted through the electrostatic lens and into the reaction cell, and a second mode, in which the ion beam is reflected into an off-axis detector device.

12. The method of claim 9, wherein during a first filtering mode, ions in the ion beam having a selectable mass-to-charge are transmitted through the mass filter and into the electrostatic lens, wherein the ion beam is reflected into the off-axis detector; and a second broad-mass mode, wherein particles of a mass range that is greater than during filtering mode are transmitted through the mass filter and through the electrostatic lens, into the reaction cell.

13. (canceled)

14. (canceled)

15. A method of transmitting elemental ions through a reaction cell in a mass spectrometer, the method comprising:
i. providing at least one multipole ion guide within the reaction cell;
ii. applying an axial electric field gradient in the multipole ion guide for improving transmission of ions through the reaction cell;
iii. transmitting ions in an axial direction through the multipole ion guide wherein the axial electric field exerts a force upon the ions in the direction of transmission,
wherein the axial electric field gradient can be adjusted so that during a mass analysis, a first element is analysed with a first
setting of the axial electric field gradient in the reaction cell and a second element is analysed using a second setting of the axial electric field gradient in the reaction cell, and
iv. transmitting ions from the ion guide into a sector field mass analyzer for mass analysis followed by detecting ions using a multicollector.

16. The method of claim 15, wherein applying the axial electric field gradient, further comprises at least one of: (I) applying a range of stepwise voltages in the axial direction to at least one electrode of the reaction cell that is elongated in the axial direction, (ii) providing a resistive coating to at least one electrode of the reaction cell that is elongated in the axial direction and connecting a DC voltage supply to an end of the at least one electrode, (iii) providing at least one electrode elongated in the axial direction that is slanted along the axial direction;
wherein the at least one electrode is at least one elongated rod of the multipole and/or is at least one auxiliary electrode.

17. The method of claim 15, wherein the range of stepwise voltages changes monotonically and results in a progressive axial electric field gradient in the collision cell that accelerates ions through the multipole in the axial direction.

18. (canceled)

19. (canceled)

20. (canceled)

21. The method of claim 15, wherein the ions are axially accelerated by the electric field provided by the voltages applied to the elongated rods of the multipole ion guide or to at least one auxiliary electrode in the multipole ion guide.

22. A method of increasing sensitivity of an elemental mass analysis in a mass spectrometer, the method comprising:
i. providing an ion beam comprising at least one elemental ion into a multipole reaction cell;
ii. applying an axial electric field gradient in the reaction cell, wherein the axial electric field gradient can be adjusted so that during a mass analysis, a first element is analysed with a first setting of the axial electric field gradient in the reaction cell and a second element is analysed using a second setting of the axial electric field gradient in the reaction cell; and
iii. analyzing an ion abundance or isotope ratio of the at least one elemental ion transmitted through the multipole reaction cell using a multicollector,

23. The method of claim 22, wherein prior to the transmission of ions through the multipole reaction cell, the reaction cell is filled with at least one reaction gas, and wherein the elemental ions comprise elemental ions that have an atomic mass similar to, or the same as, or less than the atomic or molecular mass of the reaction gas.

24. The method of claim 22, wherein the at least one elemental ion has an atomic mass of less than 40 amu, preferably less than 30 amu, more preferably less than 20 amu.

25. The method of claim 22, wherein the isotope ratio is determined using a multicollector sector mass analyzer.

26. The method of claim 22, wherein the reaction gas is selected from H₂, O₂, NH₃, and SO₂.

27. The method of claim 22, wherein the reaction gas is provided into the reaction cell at a flow rate of 0.5 to 10 mL/min, preferably 1 to 8 mL/min, more preferably 2 to 6 mL/min.

28. (canceled)

29. The method of claim 22, wherein an energy spread of the at least one elemental ion after transmission through the reaction cell is reduced compared to an energy spread of the ion generated by an ion source by at least about 50%.

30. The method of claim 22, wherein the energy spread of the at least one elemental ion after transmission through the reaction cell is less than 1 eV.

31. A mass spectrometer for mass analysis of elements in a sample, comprising
a. at least one ion source, for generating an ion beam from a sample, the ion beam comprising elemental ions and optionally molecular ions that interfere with elemental ions in a mass spectrum;
b. at least one reaction cell arranged downstream of the ion source, the reaction cell having an internal volume through which ions travelling in an axial direction from the ion source are transmitted;
c. at least one sector field mass analyzer, arranged downstream from the reaction cell,
d. at least one multicollector detector, for detecting ions that are analyzed in the mass analyzer,
wherein the collision cell is configured to provide an axial electric field in the volume, wherein the axial electric field improves the transmission of light elemental ions through the collision cell relative to heavier elemental ions.

32. The mass spectrometer of claim 22, wherein the elemental ions comprise elemental ions that have an atomic mass similar to, or the same as, or less than the atomic or molecular mass of a reaction or reaction gas in the reaction cell.

33. The mass spectrometer of claim 22, wherein the mass analyzer is a double-focusing sector field mass analyzer.

34. The mass spectrometer of claim 22, wherein the axial field has a gradient in the range of about 0.02 V/cm to about 4 V/cm.

35. (canceled)

36. The mass spectrometer of claim 22, wherein the mass analyzer is a single-focusing sector field mass analyzer.

37. The mass spectrometer of claim 22, wherein the reaction cell comprises at least one multipole ion guide.

38. (canceled)

39. The mass spectrometer of claim 37, wherein the multipole comprises a plurality of rod electrodes configured to be supplied with RF voltage, wherein the rods are arranged according to at least one of the following arrangements to provide an axial electric field gradient: (i) at least some of the rods are slanted along the axial direction, (ii) the rods are each provided as a plurality of segments spaced along the axial direction wherein stepped voltages, are applied to the segments, (iii) the rods have a resistive coating or comprises a resistive material, (iv) at least one of the rods are tapered along the axial direction.

40. The mass spectrometer of claim 31, wherein the reaction cell comprises at least one auxiliary electrode disposed to create an axial field within the volume of the reaction cell.

41. (canceled)

42. The mass spectrometer of claim 31, wherein the reaction cell is configured to provide an axial field along all of, or a portion of, the internal volume.

43. (canceled)

44. The mass spectrometer of claim 31, wherein the ion source is selected from: an inductively coupled plasma (ICP) ion source and secondary ion mass spectrometry (SIMS) ion source.

45. (canceled)

46. The mass spectrometer of claim 31, further comprising at least one mass filter, arranged upstream from the reaction cell and downstream from the ion source.

47. The mass spectrometer of claim 31, further comprising at least one electrostatic lens, for selectively and alternately transmitting or reflecting the ion beam,. wherein the electrostatic lens is preferably arranged between the mass filter and the reaction cell.

48. (canceled)

49. The mass spectrometer of claim 31, wherein the axial electric field has a monotonically progressive electric field gradient in the reaction cell.

50. The mass spectrometer of claim 31, wherein the reaction cell comprises a plurality of auxiliary electrodes that are arranged between adjacent rods in the multipole ion guide.

51-54. (canceled)
